(19) United States
(12) Patent Application Publication
(10) Pub. No.: US 2026/0066941 A1
(43) Pub. Date: Mar. 5, 2026

(54) DIFFERENTIAL ANTENNA INTERFACING FOR HIGH FREQUENCY CELLULAR COMMUNICATIONS

(71) Applicant: Skyworks Solutions, Inc., Irvine, CA (US)

(72) Inventor: David Richard Pehlke, Westlake Village, CA (US)

(21) Appl. No.: 19/314,590

(22) Filed: Aug. 29, 2025

Related U.S. Application Data
(60) Provisional application No. 63/690,937, filed on Sep. 5, 2024.

(51) Int. Cl. H04B 1/44; H04B 1/04; H04B 1/401

(52) U.S. Cl. CPC H04B 1/44; H04B 1/04; H04B 1/401; H04B 2001/0408

(57) ABSTRACT

Apparatus and methods for differential antenna interfacing for high frequency cellular communications, such as Frequency Range 3 (FR3) communications for cellular fifth generation (5G), are disclosed. In certain embodiments, a mobile device includes a front-end system and a differential antenna having a differential interface coupled to the front-end system. The front-end system provides the differential interface of the differential antenna with a differential transmit signal having a frequency of at least 7 gigahertz (GHz).

### CROSS-REFERENCE TO RELATED APPLICATIONS

This application claims the benefit of priority under 35 U.S. C. § 119 of U.S. Provisional Patent Application No. 63/690937, filed Sep. 5, 2024 and titled “DIFFERENTIAL ANTENNA INTERFACING FOR HIGH FREQUENCY CELLULAR COMMUNICATIONS,” which is herein incorporated by reference in its entirety.

### BACKGROUND

### Field Embodiments of the invention relate to electronic systems, and in particular, to radio frequency electronics.

### Description of Related Technology

Radio frequency (RF) communication systems can be used for transmitting and/or receiving signals of various frequencies. Examples of RF communication systems include, but are not limited to, mobile phones, tablets, base stations, network access points, customer-premises equipment (CPE), laptops, and wearable electronics.

### SUMMARY

In certain embodiments, the present disclosure relates to a mobile device. The front-end system is configured to output a differential transmit signal having a frequency of at least 7 gigahertz, and a differential antenna having a differential interface configured to receive the differential transmit signal from the front-end system.

In various embodiments, the front-end system includes a differential transmit/receive switch configured to provide the differential transmit signal to the differential interface of the differential antenna in a transmit mode. According to a number of embodiments, the front-end system further includes a shared differential transmit/receive filter electrically connected between the differential transmit/receive switch and the differential interface of the differential antenna, the differential transmit/receive switch further configured to receive a differential receive signal from the differential interface of the differential antenna through the shared differential transmit/receive filter in a receive mode. In accordance with several embodiments, the front-end system further includes a differential power amplifier configured to provide the differential transmit signal to a differential input of the differential transmit/receive switch, and a differential low noise amplifier configured to receive a differential receive signal from a differential output of the differential transmit/receive switch.

In some embodiments, the mobile device further includes a transceiver having a differential output that provides the differential transmit signal to the front-end system.

In several embodiments, the mobile device further includes a transceiver having a single-ended output that provides a single-ended transmit signal to the front-end system, the front-end system configured to provide a single-ended to differential signal conversion to the single-ended transmit signal to generate the differential transmit signal. According to a number of embodiments, the front-end system includes a balun configured to provide the single-ended to differential signal conversion. In accordance with some embodiments, the front-end system further includes a single-ended power amplifier configured to receive the single-ended transmit signal and a single-ended output coupled to the balun. According to various embodiments, the front-end system further includes a differential power amplifier configured to receive the differential transmit signal from the balun. In accordance with a number of embodiments, the front-end system includes an acoustic wave filter configured to provide the single-ended to differential signal conversion.

In various embodiments, the differential transmit signal is in frequency range three (FR3).

In some embodiments, the differential transmit signal has a frequency of at least 10 gigahertz. According to a number of embodiments, the differential transmit signal has a frequency less than 20 gigahertz.

In certain embodiments, the present disclosure relates to a method of antenna interfacing in a mobile device. The method includes outputting a differential transmit signal having a frequency of at least 7 gigahertz from a front-end system, and receiving the differential transmit signal from the front-end system at a differential interface of a differential antenna.

In various embodiments, the method further includes providing the differential transmit signal to the differential interface of the differential antenna in a transmit mode using a differential transmit/receive switch of the front-end system. According to a number of embodiments, the method further includes providing the differential transmit signal through a shared differential transmit/receive filter of the front-end system in the transmit mode, and receiving a differential receive signal from the differential interface of the differential antenna at the differential transmit/receive switch in a receive mode. In accordance with several embodiments, the method further includes providing the differential transmit signal to a differential input of the differential transmit/receive switch using a differential power amplifier of the front-end system, and receiving a differential receive signal from a differential output of the differential transmit/receive switch at a differential low noise amplifier of the front-end system.

In several embodiments, the method further includes providing the differential transmit signal to the front-end system from a differential output of a transceiver.

In various embodiments, the method further includes providing a single-ended transmit signal to the front-end system from a single-ended output of a transceiver, and converting the single-ended transmit signal to the differential transmit signal by providing a single-ended to differential signal conversion in the front-end system. According to a number of embodiments, the method further includes providing the single-ended to differential signal conversion using a balun of the front-end system. In accordance with several embodiments, the front-end system further includes a single-ended power amplifier configured to receive the single-ended transmit signal and a single-ended output coupled to the balun. According to some embodiments, the front-end system further includes a differential power amplifier configured to receive the differential transmit signal from the balun. In accordance with a number of embodiments, the method further includes providing the single-ended to differential signal conversion using an acoustic wave filter of the front-end system.

In several embodiments, the differential transmit signal is in frequency range three (FR3).

In some embodiments, the differential transmit signal has a frequency of at least 10 gigahertz. According to a number of embodiments, the differential transmit signal has a frequency less than 20 gigahertz.

In certain embodiments, the present disclosure relates to a front-end system for a mobile device. The front-end system includes a differential interface configured to couple to a differential antenna, and a differential transmit/receive switch configured to provide a differential transmit signal having a frequency of at least 7 gigahertz to the differential interface.

In some embodiments, the differential transmit/receive switch is configured to provide the differential transmit signal to the differential interface in a transmit mode. According to a number of embodiments, the front-end system further includes a shared differential transmit/receive filter electrically connected between the differential transmit/receive switch and the differential interface, the differential transmit/receive switch further configured to receive a differential receive signal from the differential interface through the shared differential transmit/receive filter in a receive mode. In accordance with several embodiments, the front-end system further includes a differential power amplifier configured to provide the differential transmit signal to a differential input of the differential transmit/receive switch, and a differential low noise amplifier configured to receive a differential receive signal from a differential output of the differential transmit/receive switch.

In various embodiments, the front-end system further includes a differential input for receiving the differential transmit signal from a differential output of a transceiver.

In some embodiments, the front-end system further includes a single-ended input for receiving a single-ended transmit signal from a single-ended output of a transceiver, the front-end system providing a single-ended to differential signal conversion to the single-ended transmit signal to generate the differential transmit signal. According to a number of embodiments, the front-end system further includes a balun configured to provide the single-ended to differential signal conversion. In accordance with several embodiments, the front-end system further includes a single-ended power amplifier having a single-ended input configured to receive the single-ended transmit signal and a single-ended output coupled to the balun. According to various embodiments, the front-end system further includes a differential power amplifier configured to receive the differential transmit signal from the balun. In accordance to a number of embodiments, the front-end system further includes an acoustic wave filter configured to provide the single-ended to differential signal conversion.

In various embodiments, the differential transmit signal is in frequency range three (FR3).

In several embodiments, the differential transmit signal has a frequency of at least 10 gigahertz. According to a number of embodiments, the differential transmit signal has a frequency less than 20 gigahertz.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a schematic diagram of one embodiment of a mobile device with differential antenna interfacing.

FIG. 6B is a schematic diagram of another embodiment of a mobile device with differential antenna interfacing.

FIG. 6C is a schematic diagram of another embodiment of a mobile device with differential antenna interfacing.

FIG. 6D is a schematic diagram of another embodiment of a mobile device with differential antenna interfacing.

FIG. 6E is a schematic diagram of another embodiment of a mobile device with differential antenna interfacing.

FIG. 6F is a schematic diagram of another embodiment of a mobile device with differential antenna interfacing.

FIG. 7A is a schematic diagram of one embodiment of a filter with a single-ended input and a differential output.

FIG. 7B is a schematic diagram of another embodiment of a filter with a single-ended input and a differential output.

FIG. 7C is a schematic diagram of another embodiment of a filter with a single-ended input and a differential output.

FIG. 8 is a schematic diagram of another embodiment of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15 and introduced Phase 2 of 5G technology in Release 16. Subsequent 3GPP releases will further evolve and expand 5G technology. 5G technology is also referred to herein as 5G New Radio (NR). 3GPP has also introduced various proposals for sixth generation (6G) technology.

5G and/or 6G supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, 5G and/or 6G.

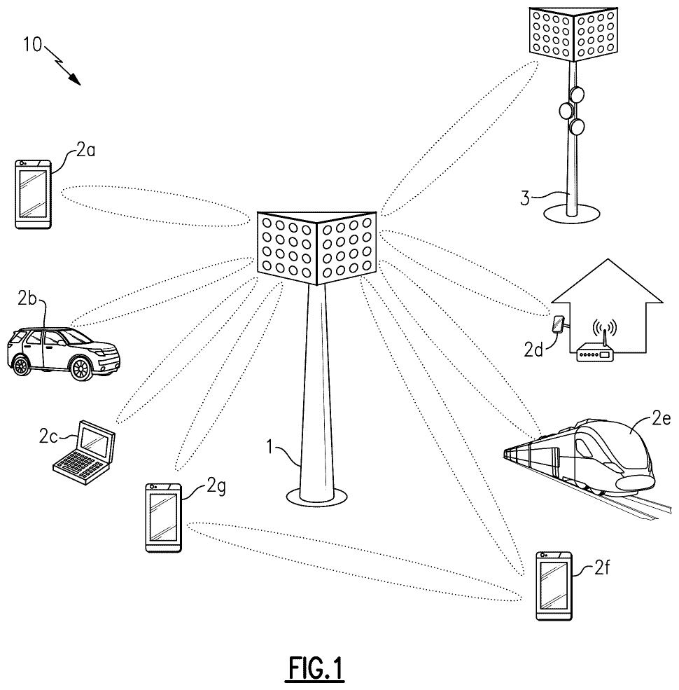

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment (UE), including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE, 5G NR, and/or 6G. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, 6G, and WiFi technologies. In certain implementations, enhanced license assisted access (eLAA) is used to aggregate one or more licensed frequency carriers (for instance, licensed 4G LTE, 5G NR, and/or 6G frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

The depicted communication links can operate over a wide variety of frequencies. For example, cellular user equipment can communicate using beamforming and/or other techniques over a wide range of frequencies, including, for example, FR1 (400 MHz to 7 GHz), FR2 (24 GHz to 71 GHz) (which includes FR2-1 (24 GHz to 52 GHz) and FR2-2 (52 GHz to 71 GHz)), and/or FR3 (7 GHz to 24 GHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

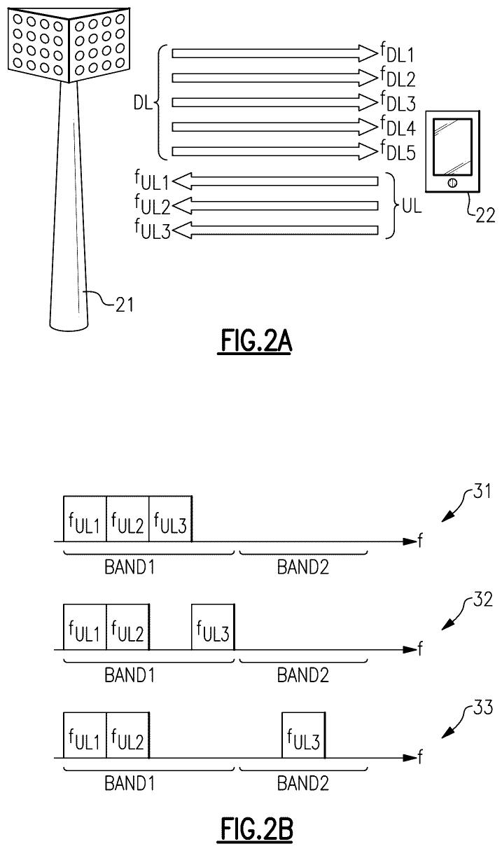

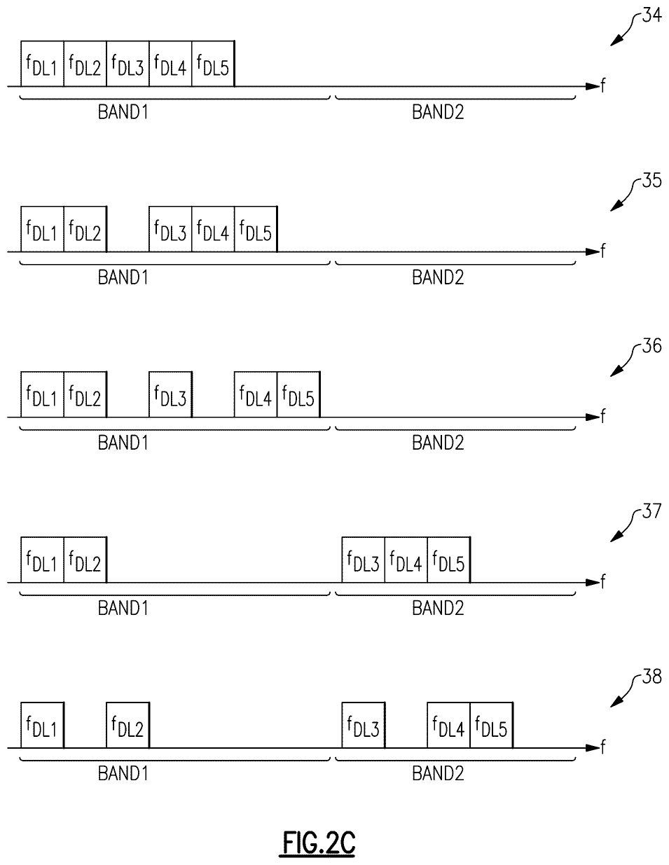

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6GHz band (5925 MHz to 7125MHz).

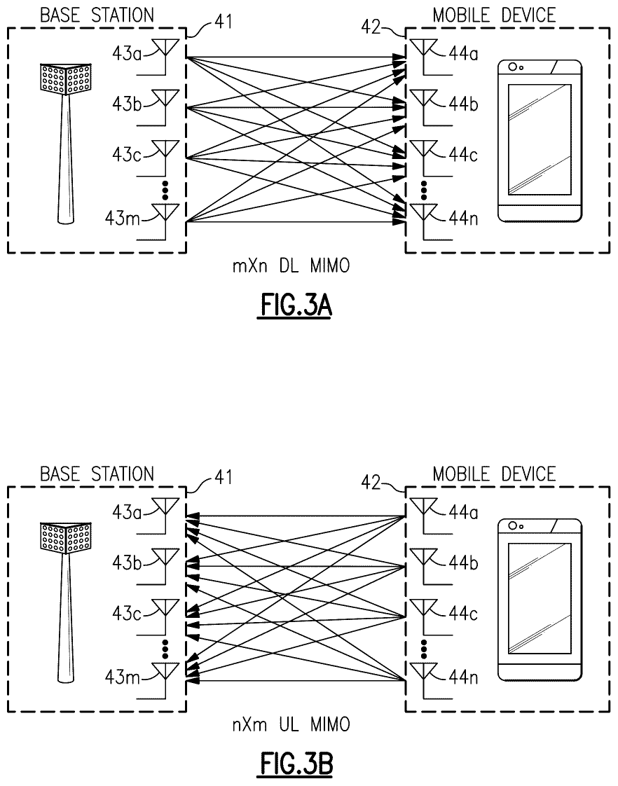

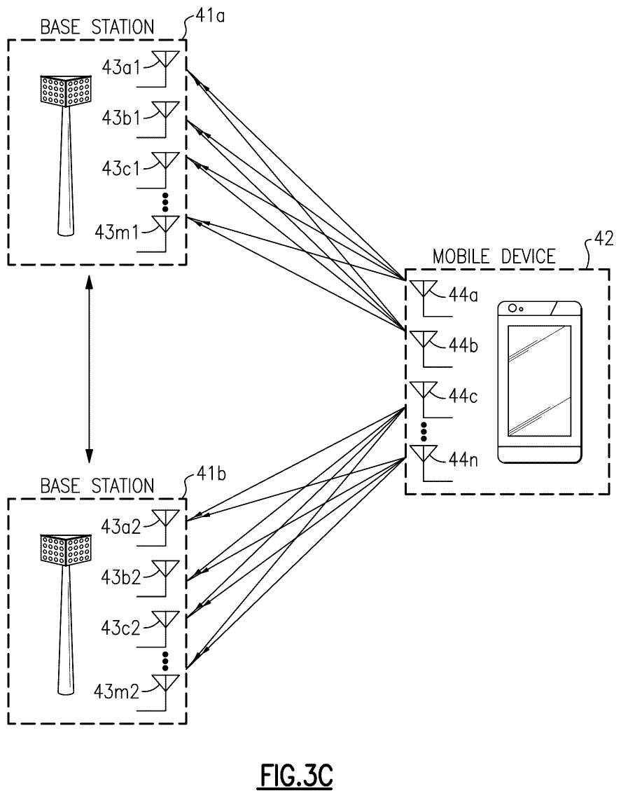

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, ... 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

FIG. 4 is a schematic diagram of an example dual connectivity network topology. This architecture can leverage LTE legacy coverage to ensure continuity of service delivery and the progressive rollout of 5G and/or 6G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G, 5G, and/or 6G carriers being simultaneously transmitted from a UE. Transmitting multiple carriers of different radio access technologies (RATs) in a UE, such as a phone, typically involves two or more power amplifiers (PAs) being active at the same time.

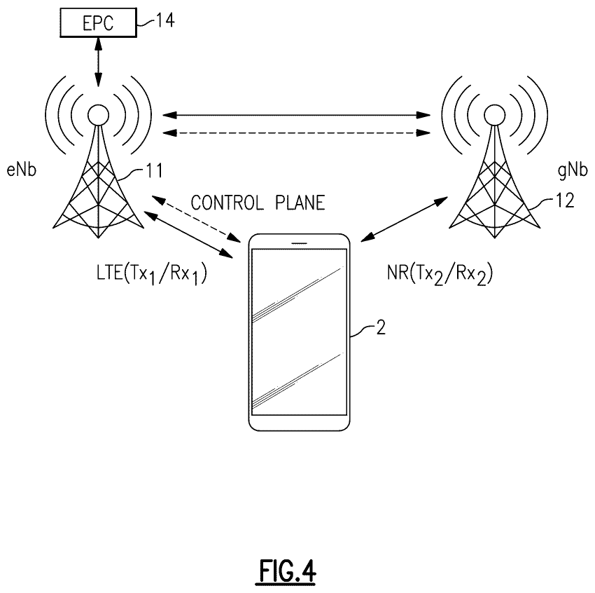

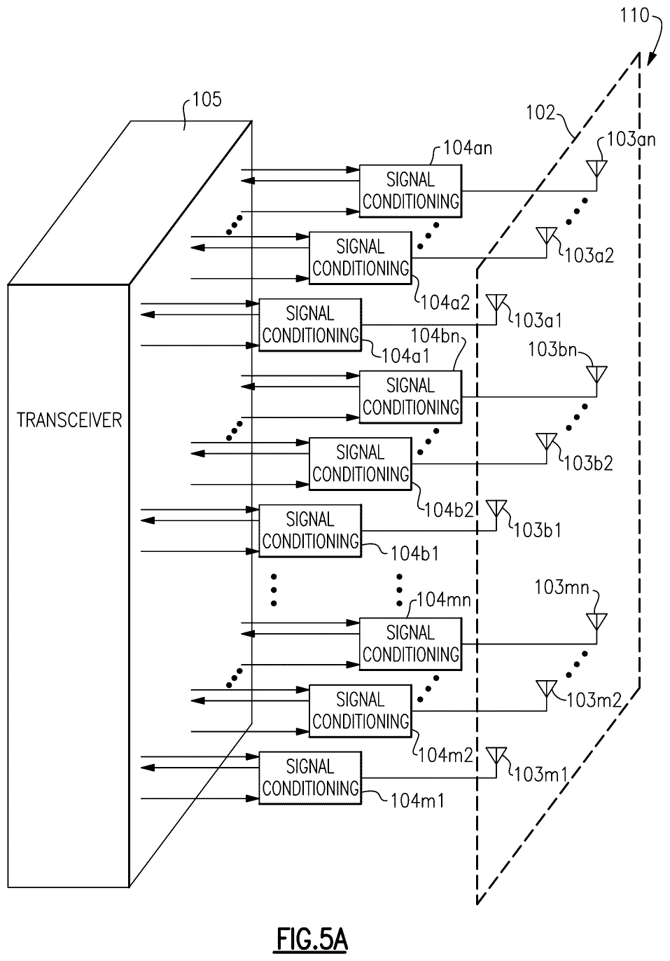

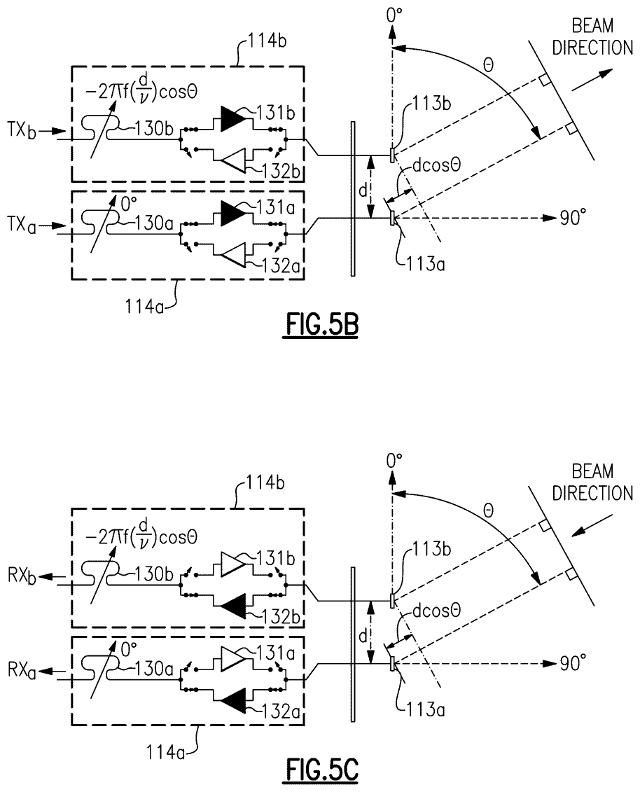

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle θ, which in this example has a value of about 90°when the transmit beam direction is substantially perpendicular to a plane of the antenna array and a value of about 0°when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/ν)cosθ radians, where f is the fundamental frequency of the transmit signal, d is the distance between the antenna elements, ν is the velocity of the radiated wave, and π is the mathematic constant pi.

In certain implementations, the distance d is implemented to be about ⅓λ, where λ is the wavelength of the fundamental component of the transmit signal. In such implementations, the second phase shifter 130b can be controlled to provide a phase shift of about −πcosθ radians to achieve a transmit beam angle θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/ν)cosθ radians to achieve a desired receive beam angle θ. In implementations in which the distance d corresponds to about ½λ, the phase difference can be selected to about equal to −πcosθ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

### Differential Antenna Interfacing for High Frequency Cellular Communications

Mobile devices for advanced cellular standards, such as 5G and/or 6G, can be used to wirelessly communicate RF signals in various frequency ranges, such as in the range of about 400 MHz to about 7 GHz for Frequency Range 1 (FR1), in the range of about 24 GHz to about 71 GHz for Frequency Range 2 (FR2), or in the range of about 7 GHz to 24 GHz for Frequency Range 3 (FR3).

For the FR1 frequency range, front-end systems with single-ended RF circuits are typically used. Additionally, for the FR2 frequency range, beamforming is provided using single-ended patch antennas arranged in an array.

However, the FR3 frequency range is problematic since it is too high in frequency to use entirely legacy FR1-style front-end systems due to various performance challenges of single-ended RF circuits. For example, implementation of single-ended RF circuits at higher frequencies having limitations in achievable gain and/or efficiency for active amplifiers, high losses in impedance transformation networks and/or traces, and/or poor isolation due to electromagnetic coupling. Such single-ended impairments can manifest from shared ground inductance that leads to ground bounce, signal coupling, degeneration of single-ended gain, and/or inherent imbalance in signal and ground currents that couple more broadly due to a lack of electromagnetic cancellation.

Moreover, the FR3 frequency range is too low in frequency to provide phased-array solutions that are very small and compact. For instance, antenna size is inversely proportional to frequency and thus phased-array solutions for FR3 can be much larger than that for FR2.

Apparatus and methods for differential antenna interfacing for high frequency cellular communications, such as FR3 communications, are disclosed. In certain embodiments, a mobile device includes a front-end system and a differential antenna having a differential interface coupled to the front-end system. The front-end system provides the differential interface of the differential antenna with a differential transmit signal having a frequency of at least 7 gigahertz (GHz).

Accordingly, a differential antenna with a differential interface is used for the transmission of high frequency RF signals, such as those of at least 7 GHz, for instance, FR3 signals. Furthermore, such a differential antenna can also be used to support reception of high frequency RF signals. In certain implementations, the differential antenna provides a differential receive signal to the RF front-end along a shared RF signal path. For example, the front-end system can include a differential transmit/receive (T/R) switch that controls access of the front-end system to the differential antenna using time-division duplexing (TDD).

In certain implementations, the differential transmit signal is provided along an RF signal path through the front-end system providing a single-ended to differential signal conversion. For example, to interface to an entirely differential antenna structure, the front-end system can transition from a single-ended RF signal path to a pair of balanced RF signal paths (also referred to as a differential RF signal path) at various points of an RF signal chain.

For instance, active amplifiers can become differential, a single RF path filter can become a differential filter (for instance, a pair of filters arranged in a differential configuration), and/or a T/R switch can be implemented differentially to support non-inverted and inverted signal components of RF signals. In yet another example, a filter is implemented as an acoustic wave filter having a single-ended input and a differential output. For instance, the acoustic filter can be a surface acoustic wave (SAW) filter or a temperature compensated surface acoustic wave (TC-SAW) filter providing single-ended to differential signal conversion.

The front-end system can be coupled to a transceiver that operates with either single-ended or differential RF signaling for transmit and/or receive paths. The transceiver can in turn be coupled to a baseband processor over a digital interface used to communicate digital representations of RF transmit signals and RF receive signals. A transceiver is also referred to herein as a radio frequency integrated circuit (RFIC).

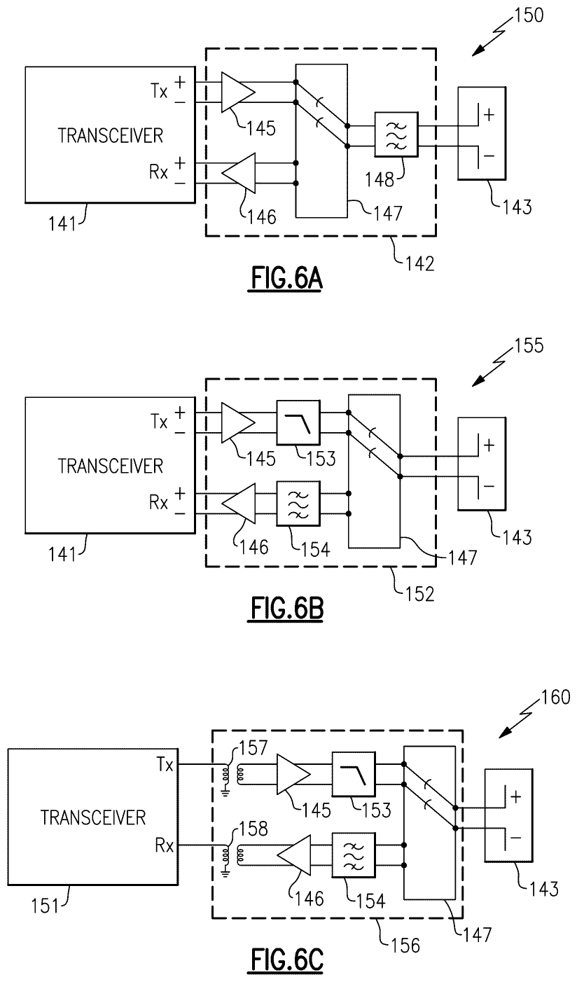

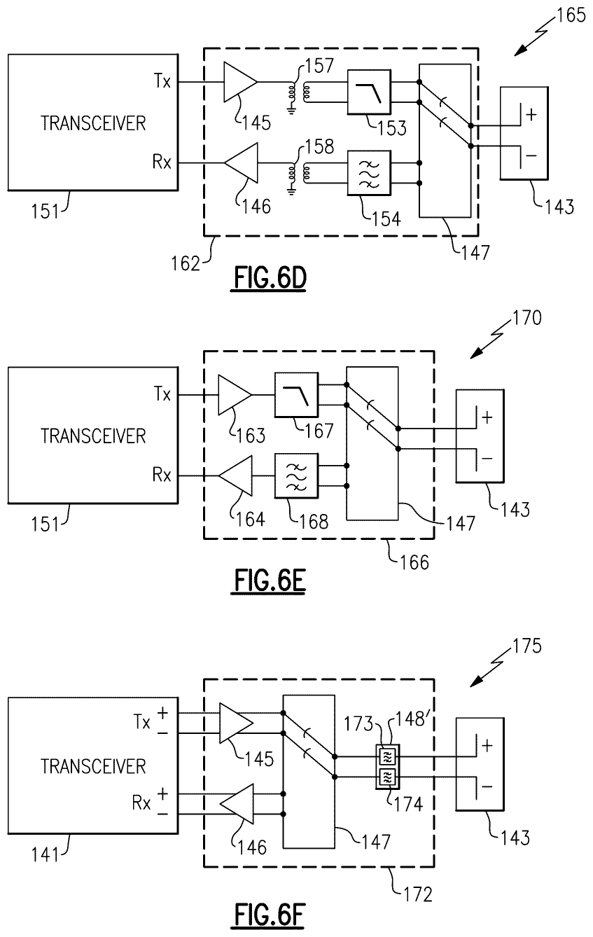

FIG. 6A is a schematic diagram of one embodiment of a mobile device 150 with differential antenna interfacing. The mobile device 150 includes a transceiver 141, a front-end system 142, and a differential antenna 143.

Although one embodiment of a mobile device with differential antenna interfacing is shown, a mobile device with differential antenna interfacing can be implemented in other ways. For example, other implementations of front-end systems and/or transceivers can be used. Furthermore, the mobile device 150 can include additional components, such as those described further below with reference to FIG. 8. The mobile device 150 can represent various types of UE including, but not limited to, mobile phones, tablets, laptops, IoT devices, wearable electronics, wireless-connected vehicles, and/or a wide variety of other communication devices.

In the illustrated embodiment, the differential antenna 143 includes a pair of traces that form a radiating element of the antenna. In certain implementations, the differential antenna operates as a dipole having substantially balanced and/or symmetric excitation. For instance, the pair of traces can operate in a push-pull configuration that provides significantly less signal leakage relative to a single-ended configuration suffering from uncertain ground return (ground bounce), electromagnetic coupling, and/or poor isolation.

The differential antenna 143 includes a differential interface that is coupled to the front-end system 142. For example, in the illustrated embodiment, a first terminal of the differential interface carries a non-inverted signal component of an RF signal handled by the first trace of the antenna's radiating element, while a second terminal of the differential interface carries an inverted signal component of the RF signal handled by the second trace of the antenna's radiating element. The non-inverted signal component and inverted signal component of an RF signal have a phase separation of about π radians or about 180 degrees.

As shown in FIG. 6A, the front-end system 142 includes a differential power amplifier 145, a differential low noise amplifier (LNA) 146, a differential T/R switch 147, and a shared T/R differential filter 148.

In the illustrated embodiment, the shared T/R differential filter 148 is electrically connected to the differential interface of the differential antenna 143 and serves both to filter a differential transmit signal provided to the differential antenna 143 from the front-end system 142 and to filter a differential receive signal received by the front-end system 142 from the differential antenna 143. In certain implementations, the differential transmit signal and the differential receive signal have a carrier frequency of at least 7 GHz. For example, the differential transmit signal and the differential receive signal can be in the FR3 frequency range.

With continuing reference to FIG. 6A, the differential transmit/receive switch 147 is electrically connected to the differential interface of the differential antenna 143 through the shared T/R differential filter 148. The differential T/R switch 147 includes a differential input electrically connected to a differential output of the differential power amplifier 145, and a differential output electrically connected to a differential input of the differential LNA 146.

As shown in FIG. 6A, a differential input of the differential power amplifier 145 is electrically connected to a differential output of the transceiver 141, while a differential output of the differential LNA 146 is electrically connected to a differential input of the transceiver 141. Thus, the transceiver or RFIC 141 outputs a differential transmit signal and receives a differential receive signal, in this embodiment. However, the teachings herein are also applicable to implementations in which a transceiver outputs a single-ended transmit signal and/or receives a single-ended receive signal.

In the illustrated embodiment, the differential T/R switch 147 is selectively operable in a transmit mode in which the differential T/R switch 147 electrically connects the differential output of the differential power amplifier 145 to the differential interface of the differential antenna 143 through the shared T/R differential filter 148. Thus, the differential transmit signal outputted from the differential power amplifier 145 is provided to the differential interface of the differential antenna 143 in the transmit mode. The differential T/R switch 147 is also selectively operable in a receive mode in which the differential T/R switch 147 electrically connects the differential interface to the differential input of the differential LNA 146. Thus, the differential receive signal received from the differential antenna 143 is provided to the differential LNA 146 in the receive mode.

In certain implementations, the mobile device 150 operates using TDD, and the differential T/R switch 147 operates in the transmit mode during a transmit time slot for TDD and in the receive mode during a receive time slot for TDD.

Using the differential power amplifier 145 for amplification of the differential transmit signal can provide several benefits. For example, a fully differential power amplifier having a power amplifier core implemented with bipolar transistors benefits from higher impedance at each of its collectors (typically twice as large for differential versus single-ended), thus reducing the extremely high current running in the lone single-ended supply interfacing and its associated current times resistance (I*R) voltage drop and/or other parasitics. Such a differential power amplifier can also eliminate even-order harmonics through symmetric balance of the differential operation, along with parasitic ground current and degeneration associated with gain and/or efficiency reduction that occurs as a result for the single-ended implementation. Moreover, the differential power amplifier can have more gain capability and higher efficiency at higher frequency, with less electromagnetic coupling issues due to differential cancellations.

The differential LNA 146 similarly benefits from these aspects as well as from improved sensitivity to ground coupling due to the effective isolation of the LNA signal current loop from the ground path and parasitic common-mode signals.

In certain implementations, the differential amplifiers include amplifier cores in which the size of each half of the differential PA is sized to support the same total power as a single-ended solution to first order. Thus, the amplifier element array need not be increased in size and in fact may shrink a small amount due to the advantages of lower current and higher efficiency.

Likewise, the sizing of each half of the differential filter 148 (for instance, the size of each filter in a pair of filters arranged differentially to implement the filter 148 of FIG. 6A) can be sized downward to support half the current and/or be co-designed on the same die at similar sizing to the single-ended design apart from pad count. The switch throw/pole count of the differential T/R switch 147 doubles versus a single-ended design but also each half of the switch can be implemented to support half the power and thus can be made rugged with similar size to a single-ended design.

FIG. 6B is a schematic diagram of another embodiment of a mobile device 155 with differential antenna interfacing. The mobile device 155 includes a transceiver 141, a front-end system 152, and a differential antenna 143. The front-end system 152 includes a differential power amplifier 145, a differential LNA 146, a differential T/R switch 147, a differential transmit filter 153, and a differential receive filter 154.

The mobile device 155 of FIG. 6B is similar to the mobile device 150 of FIG. 6A, except the front-end system 152 of FIG. 6B is implemented with a separate differential transmit filter and differential receive filter rather than using the shared T/R differential filter 148 of FIG. 6A. As shown in FIG. 6B, the differential transmit filter 153 is electrically connected between the differential output of the differential power amplifier 145 and the differential input to the differential T/R switch 147, while the differential receive filter 154 is electrically connected between the differential output of the differential T/R switch 147 and the differential input of the differential LNA 146.

In the illustrated embodiment, the differential transmit filter 153 is low pass and the differential receive filter 154 is band pass. However, other implementations are possible. For example, in another embodiment, the differential transmit filter 153 is band pass. The depicted filters can be implemented in a variety of ways including, but not limited to, using acoustic wave filter technologies.

FIG. 6C is a schematic diagram of another embodiment of a mobile device 160 with differential antenna interfacing. The mobile device 160 includes a transceiver 151, a front-end system 156, and a differential antenna 143. The front-end system 156 includes a differential power amplifier 145, a differential LNA 146, a differential T/R switch 147, a differential transmit filter 153, a differential receive filter 154, a transmit-path balun 157, and a receive-path balun 158.

The mobile device 160 of FIG. 6C is similar to the mobile device 155 of FIG. 6B, except that the transceiver 151 and the front-end system 156 of FIG. 6C interface using single-ended signaling rather than differential signaling. For example, the transceiver 151 of FIG. 6C outputs a single-ended transmit signal, which is converted by the transmit-path balun 157 to a differential transmit signal that is provided to a differential input of the differential power amplifier 145. Additionally, the receive-path balun 158 converts a differential receive signal outputted from the differential LNA 146 to a single-ended receive signal that is provided to the transceiver 151.

Accordingly, the front-end system 156 of FIG. 6C provides single-ended to differential signal conversions for both transmit and receive signal paths.

FIG. 6D is a schematic diagram of another embodiment of a mobile device 165 with differential antenna interfacing. The mobile device 165 includes a transceiver 151, a front-end system 162, and a differential antenna 143. The front-end system 162 includes a single-ended power amplifier 163, a single-ended LNA 164, a differential T/R switch 147, a differential transmit filter 153, a differential receive filter 154, a transmit-path balun 157, and a receive-path balun 158.

The mobile device 165 of FIG. 6D is similar to the mobile device 160 of FIG. 6C, except that the front-end system 162 of FIG. 6D includes single-ended amplifiers. Additionally, the transmit-path balun 157 is electrically connected between the single-ended output of the single-ended power amplifier 163 and a differential input of the differential transmit filter 153, while the receive-path balun 158 is electrically connected between a differential output of the differential receive filter 154 and a single-ended input of the single-ended LNA 146.

FIG. 6E is a schematic diagram of another embodiment of a mobile device 170 with differential antenna interfacing. The mobile device 170 includes a transceiver 151, a front-end system 166, and a differential antenna 143. The front-end system 166 includes a differential T/R switch 147, a single-ended power amplifier 163, a single-ended LNA 164, a single-ended to differential transmit filter 167, and a differential to single-ended receive filter 168.

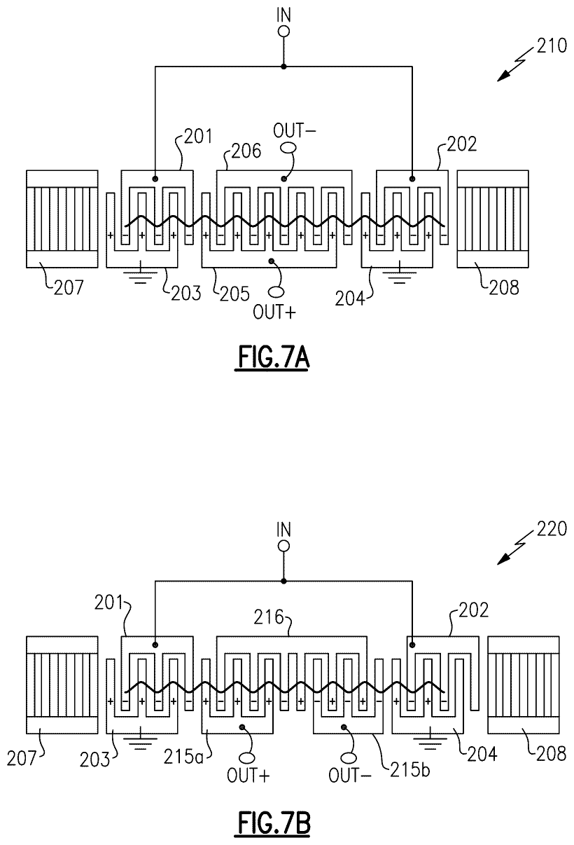

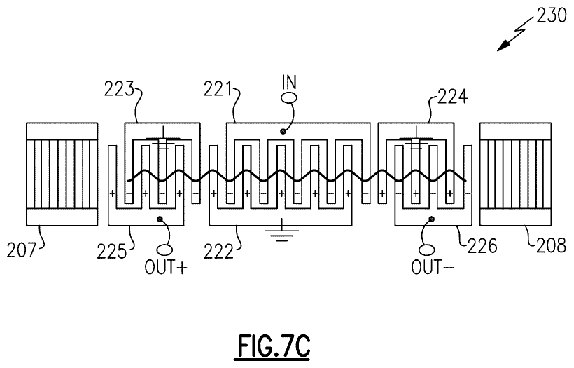

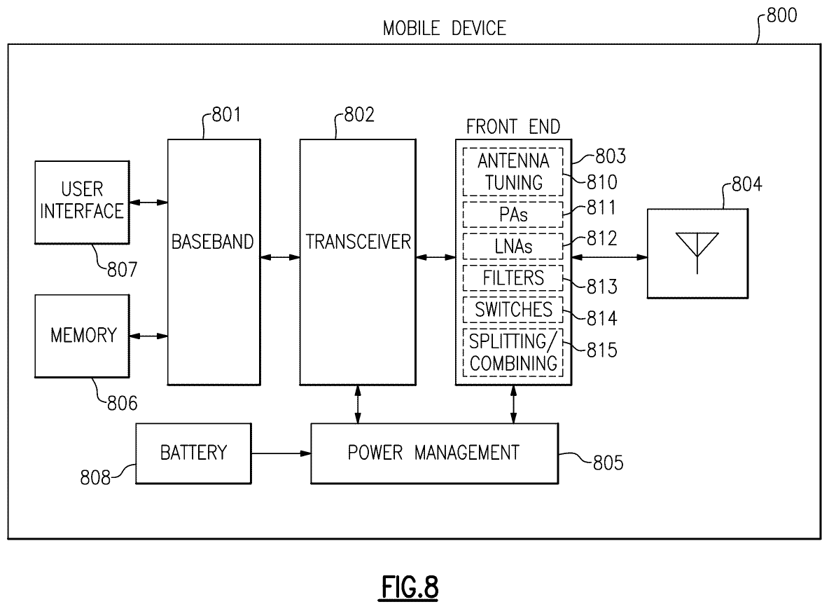

The mobile device 170 of FIG. 6E is similar to the mobile device 165 of FIG. 6D, except that the front-end system 166 of FIG. 6E omits the transmit-path balun 157 and the receive-path balun 158 of FIG. 6D in favor of including filters that provide single-ended to differential signal conversions. For example, such filters can be implemented as acoustic wave filters, such as those described further below with respect to FIG. 7A to FIG. 7C.

FIG. 6F is a schematic diagram of another embodiment of a mobile device 175 with differential antenna interfacing. The mobile device 175 includes a transceiver 141, a front-end system 172, and a differential antenna 143. The front-end system 172 includes a differential power amplifier 145, a differential LNA 146, a differential T/R switch 147, and a shared T/R differential filter 148′.

The mobile device 175 of FIG. 6F is similar to the mobile device 150 of FIG. 6A, except the front-end system 172 of FIG. 6F depicts the shared T/R differential filter 148′ as explicitly including a first filter 173 and a second filter 174 arranged differentially. Such filters form half-filter structures that collectively operate as a differential filter. The filters 173 and 174 can be separate standalone components (for instance, separate or discrete acoustic wave filters each surface mounted to a circuit board) arranged differentially or integrated as a single component (for instance, as a single discrete acoustic wave filter).

FIG. 7A is a schematic diagram of one embodiment of a filter 210 with a single-ended input (IN) and a differential output (including a first output OUT+ and a second output OUT−). The filter 210 includes a first input transducer structure 201, a second input transducer structure 202, a first grounded transducer structure 203, a second grounded transducer structure 204, a first output transducer structure 205, a second output transducer structure 206, a first dummy transducer structure 207, and a second dummy transducer structure 208. Although shown as including a single-ended input and differential output, the filter 210 can also operate in reverse with a differential input and a single-ended output.

As shown in FIG. 7A, the first input transducer structure 201 includes a group of electrodes connected to the single-ended input (IN) and interdigitated with a group of electrodes of the first grounded transducer structure 203. Additionally, the second input transducer structure 202 includes a group of electrodes connected to the single-ended input (IN) and interdigitated with a group of electrodes of the second grounded transducer structure 204. The first output transducer structure 205 includes a group of electrodes connected to the first output (OUT+) and interdigitated with a group of electrodes of the second output transducer structure 206 that are connected to the second output (OUT−). The output transducer structures 205/206 are positioned between the input transducer structures 201/202, in this embodiment.

The dummy transducer structures 207/208 are included to aid in improving yield and enhancing manufacturability.

The filter 210 depicts one example of an acoustic wave filter that can provide single-ended to differential signal conversion. Although the filter 210 includes a single-ended input and a differential output, the filter 210 can be adapted to operate with a differential input and a single-ended output. Thus, the filter 210 depicts on example of a filter suitable for implementing the filter 167 and/or the filter 168 of FIG. 6E.

FIG. 7B is a schematic diagram of another embodiment of a filter 220 with a single-ended input (IN) and a differential output (OUT+/OUT−). The filter 220 includes a first input transducer structure 201, a second input transducer structure 202, a first grounded transducer structure 203, a second grounded transducer structure 204, a first output transducer structure 215a, a second output transducer structure 215b, an output reference transducer structure 216, a first dummy transducer structure 207, and a second dummy transducer structure 208.

The filter 220 of FIG. 7B is similar to the filter 210 of FIG. 7A, except that the filter 220 of FIG. 7B includes a different transducer implementation for the differential output. In particular, the first output transducer structure 215a includes a group of electrodes connected to the first output (OUT+) and interdigitated with a first group of electrodes of the output reference transducer structure 216, which in certain implementations can be grounded. Additionally, the second output transducer structure 215b includes a group of electrodes connected to the second output (OUT−) and interdigitated with a second group of electrodes of the output reference transducer structure 216. The output transducer structures 215a/215b are positioned between the input transducer structures 201/202, in this embodiment.

The filter 220 of FIG. 7B depicts another example of a filter suitable for implementing the filter 167 and/or the filter 168 of FIG. 6E.

FIG. 7C is a schematic diagram of another embodiment of a filter 230 with a single-ended input (IN) and a differential output (OUT+/OUT−). The filter 230 includes an input transducer structure 221, a first grounded transducer structure 222, a second grounded transducer structure 223, a third grounded transducer structure 224, a first output transducer structure 225, a second output transducer structure 226, a first dummy transducer structure 207, and a second dummy transducer structure 208.

As shown in FIG. 7C, the input transducer structure 201 includes a group of electrodes connected to the single-ended input (IN) and interdigitated with a group of electrodes of the first grounded transducer structure 222. Additionally, the first output transducer structure 225 includes a group of electrodes connected to the first output (OUT+) and interdigitated with a group of electrodes of the second grounded transducer structure 223. Furthermore, the second output transducer structure 226 includes a group of electrodes connected to the second output (OUT−) and interdigitated with a group of electrodes of the third grounded transducer structure 224. The input transducer structure 221 is positioned between the output transducer structures 225/226, in this embodiment.

The filter 230 of FIG. 7C depicts yet another example of a filter suitable for implementing the filter 167 and/or the filter 168 of FIG. 6E.

FIG. 8 is a schematic diagram of one embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, 6G, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals. Such separate transceiver circuits or dies can receive separate RF split signals from the front-end systems implemented in accordance with the teachings herein.

The front-end system 803 aids in conditioning signals transmitted to and/or received from the antennas 804. In the illustrated embodiment, the front-end system 803 includes antenna tuning circuitry 810, power amplifiers (PAs) 811, low noise amplifiers (LNAs) 812, filters 813, switches 814, and signal splitting/combining circuitry 815.

With continuing reference to FIG. 8, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards. At least one of the antennas 804 is implemented with a differential interface in accordance with the teachings herein.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to. ” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A mobile device comprising:
a front-end system configured to output a differential transmit signal having a frequency of at least 7 gigahertz; and
a differential antenna having a differential interface configured to receive the differential transmit signal from the front-end system.

2. The mobile device of claim 1 wherein the front-end system includes a differential transmit/receive switch configured to provide the differential transmit signal to the differential interface of the differential antenna in a transmit mode.

3. The mobile device of claim 2 wherein the front-end system further includes a shared differential transmit/receive filter electrically connected between the differential transmit/receive switch and the differential interface of the differential antenna, the differential transmit/receive switch further configured to receive a differential receive signal from the differential interface of the differential antenna through the shared differential transmit/receive filter in a receive mode.

4. The mobile device of claim 2 wherein the front-end system further includes a differential power amplifier configured to provide the differential transmit signal to a differential input of the differential transmit/receive switch, and a differential low noise amplifier configured to receive a differential receive signal from a differential output of the differential transmit/receive switch.

5. The mobile device of claim 1 further comprising a transceiver having a differential output that provides the differential transmit signal to the front-end system.

6. The mobile device of claim 1 further comprising a transceiver having a single-ended output that provides a single-ended transmit signal to the front-end system, the front-end system configured to provide a single-ended to differential signal conversion to the single-ended transmit signal to generate the differential transmit signal.

7. The mobile device of claim 6 wherein the front-end system includes a balun configured to provide the single-ended to differential signal conversion.

8. The mobile device of claim 7 wherein the front-end system further includes a single-ended power amplifier configured to receive the single-ended transmit signal and a single-ended output coupled to the balun.

9. The mobile device of claim 7 wherein the front-end system further includes a differential power amplifier configured to receive the differential transmit signal from the balun.

10. The mobile device of claim 6 wherein the front-end system includes an acoustic wave filter configured to provide the single-ended to differential signal conversion.

11. The mobile device of claim 1 wherein the differential transmit signal is in frequency range three (FR3).

12. The mobile device of claim 1 wherein the differential transmit signal has a frequency of at least 10 gigahertz.

13. The mobile device of claim 12 wherein the differential transmit signal has a frequency less than 20 gigahertz.

14. A method of antenna interfacing in a mobile device, the method comprising:
outputting a differential transmit signal having a frequency of at least 7 gigahertz from a front-end system; and
receiving the differential transmit signal from the front-end system at a differential interface of a differential antenna.

15. The method of claim 14 further comprising providing the differential transmit signal to the differential interface of the differential antenna in a transmit mode using a differential transmit/receive switch of the front-end system.

16. The method of claim 15 further comprising providing the differential transmit signal through a shared differential transmit/receive filter of the front-end system in the transmit mode, and receiving a differential receive signal from the differential interface of the differential antenna at the differential transmit/receive switch in a receive mode.

17. The method of claim 15 further comprising providing the differential transmit signal to a differential input of the differential transmit/receive switch using a differential power amplifier of the front-end system, and receiving a differential receive signal from a differential output of the differential transmit/receive switch at a differential low noise amplifier of the front-end system.

18. A front-end system for a mobile device, the front-end system comprising:
a differential interface configured to couple to a differential antenna; and
a differential transmit/receive switch configured to provide a differential transmit signal having a frequency of at least 7 gigahertz to the differential interface.

19. The front-end system of claim 18 wherein the differential transmit/receive switch is configured to provide the differential transmit signal to the differential interface in a transmit mode.

20. The front-end system of claim 19 further comprising a shared differential transmit/receive filter electrically connected between the differential transmit/receive switch and the differential interface, the differential transmit/receive switch further configured to receive a differential receive signal from the differential interface through the shared differential transmit/receive filter in a receive mode.
